(19) United States
(12) Patent Application Publication
(10) Pub. No.: US 2009/0132352 A1
(43) Pub. Date: May 21, 2009

(54) Viewing Incentive

(75) Inventors: Katherine Emma Kerven, London (GB); Mark Adrian Vorbach, London (GB)

Correspondence Address: BANNER & WITCOFF, LTD., 1100 13th STREET, N.W., SUITE 1200, WASHINGTON, DC, 20005-4051, US

(73) Assignee: Lucky Break Limited, London (GB)

(21) Appl. No.: 11/885,218

(22) PCT Filed: Feb. 28, 2006
(86) PCT No.: PCT/IB2006/050623

§ 371 Date: Jan. 2, 2008

(30) Foreign Application Priority Data
Mar. 1, 2005 (GB) 0504210.6

(51) Int. Cl. G06Q 30/00

(52) U.S. Cl. 705/14

(57) ABSTRACT

The provision of a viewing incentive comprises determining a set of unique identifiers (13). The identifiers (13) may be generated for this purpose or a set of pre-existing unique identifiers, such as telephone numbers, customer reference numbers etc. A selected identifier (19) is presented in conjunction with a programme, advertisements (18) or other promotional material, e.g. superimposed over, or presented in its own right during a commercial break or other break in programme content. If an identifier (13) held by a viewer matches the selected identifier (19), a reward is allocated to the viewer. Alternatively, non-unique elements (25) forming part of the identifiers (13) may be presented and a viewer holding an identifier comprising a predetermined number of said elements (25) may be allocated a reward. In another arrangement, a question may be presented and a viewer submitting a correct answer may be allocated a reward. The identifiers (13) can be reused in further commercial breaks/programmes. These methods provide an incentive for watching advertisements/programmes, increasing their reach and effectiveness.

The invention relates to the provision of a viewing incentive to encourage viewers to watch promotional material, such as advertisements, and/or programming content. In particular, the invention relates to a method and system in which additional information is presented to viewers in conjunction with said promotional material and/or programming content, in order to increase its reach and effectiveness.

Programme content distribution services, such as terrestrial, cable, ADSL, fibre, wireless and satellite television services, are typically supported by state funding, viewer subscriptions and/or advertising revenue arising from the transmission of promotional material. The latter often takes the form of a sequence of advertisements, known as a commercial break, transmitted during breaks in programme content. The income that can be raised through advertisements is often linked to estimated viewing figures. Usually, the charges levied by the broadcasting services for the transmission of an advertisement on a particular channel during a given time slot depend on the estimated size and demographic qualities of the audience.

However, commercial breaks are often perceived as interruptions to a television programme or to the programming schedule. During a commercial break, a viewer watching a television programme may switch to another channel or perform another activity until the television programme resumes. Where a television programme is recorded and played back at a later time, the viewer can choose to fast-forward the playback in order to skip the advertisements. Furthermore, recording devices known as digital video recorders, which facilitate “ad skipping” have recently come onto the market. These activities reduce the audience for the advertisements and could, potentially, result in reduced advertising revenue.

A previous technique for inducing a viewer to watch a commercial break is described in WO 2004/099928 A1 and is based on a competition. In this prior method, a prize pool is maintained using subscription fees and advertising revenue etc. An advertisement is broadcast in conjunction with a query regarding its content. A viewer may then respond to the query and, if their response is correct, they may win a prize. The viewer is required to register their personal details in advance, or when submitting a response to the query. Such a method thus requires a user to submit a response and to disclose their personal details. This may deter viewers from entering the competition. For example, the registration process may be lengthy. Moreover, the viewer may not wish to divulge their personal details merely to enter a competition.

According to a first aspect of the invention, a method of providing an incentive to receive content transmitted via a programme content distribution service comprises determining a plurality of unique identifiers, transmitting content and a selected one of said unique identifiers via the programme content distribution service so that the selected unique identifiers is presented to recipients of said programme content distribution service in conjunction with said content, in response to a request from one of said recipients, determining whether an identifier held by said one recipient matches said selected unique identifier and, in response to a positive determination, allocating a reward to said one recipient.

Therefore, a recipient, such as a viewer of a television service or a listener of a radio service, may be rewarded if the selected unique identifier displayed with the content matches the unique identifier held by them.

The method can thus provide an incentive for recipients to watch or listen to promotional material, such as commercial breaks and sponsorship advertisements, instead of performing other activities, switching to another channel or, if playing a recording of a television programme, skipping the commercial breaks. In this manner, the audience watching the commercial breaks may be increased and its effectiveness enhanced.

Such a method can also be used to improve the reach and effectiveness of programming content, by presented the selected unique identifier during a programme.

According to this method, the recipient is not required to submit a request unless they have matched the selected identifier. They do not need to register or submit a response in order to enter the competition. Instead, the recipient wishing to take part needs merely to receive the content and check the selected identifier. This avoids the risk of discouraging recipients who may not wish to register or who would not wish to expend effort and/or expense submitting an entry to a competition. Thus, the number of recipients encouraged to consume the content may be increased when compared with prior art methods.

In addition, a recipient wishing to view the selected identifier will focus their attention on the content to a greater degree than would otherwise be the case, thus increasing the impact and effectiveness of the promotional material on the recipient.

The method may comprise displaying a series of unique identifiers during a sequence of instances of promotional material, such as a series of advertisements in a commercial break. This provides the recipients with an incentive to watch or listen to a commercial break in its entirety and/or to watch or listen to a plurality of commercial breaks.

The method may comprise distributing said identifiers to potential recipients of the programme content distribution service. For example, the identifiers may be distributed by hand, by mail or included in newspapers or magazines. Alternatively, the identifiers may be distributed electronically, through text messages or e-mail. Identifiers may be distributed to recipients whom have responded correctly to information that has been presented in conjunction with content.

The method permits the same identifiers to be used in successive transmissions of promotional material or programme content. In other words, the incentive can be provided a plurality of times without requiring the determination or distribution of new identifiers.

Said step of determining the unique identifiers may comprise obtaining a set of pre-existing unique numbers, such as a set of telephone numbers, customer reference numbers, for example for utility services or from a loyalty card programme, or a code identifying a viewing card used to receive encrypted television programme content. Alternatively, the unique identifiers may be generated for this purpose.

This aspect also provides a system for transmitting content, comprising a database to store a plurality of unique identifiers, a processor to select from said database one of said unique identifiers for presentation by a programme content distribution service and a request reception service to receive a request from one of said recipients, determine whether an identifier held by said one recipient matches said selected unique identifier and, in response to a positive determination, allocate a reward to said one recipient.

According to a second aspect of the invention, a method of providing an incentive to receive content comprises determining a plurality of unique identifiers, wherein each of said unique identifiers consists of a plurality of non-unique elements, transmitting content and at least one selected non-unique element via a programme content distribution service; so that said at least one selected non-unique element is presented to recipients of the programme content distribution service in conjunction with said content and, in response to a request from one of said recipients, determining whether a unique identifier held by said one recipient includes a predetermined number of said at least one selected non-unique elements and, in response to a positive determination, allocating a reward to said one recipient.

This method potentially provides an incentive for recipients to watch or listen to a sequence of instances of promotional material such as a series of advertisements and/or a plurality of commercial breaks. Alternatively, or additionally, the method can be used to encourage recipients to watch or listen to particular programme content.

This aspect also provides a system for transmitting content, comprising a database to store a plurality of unique identifiers, said unique identifiers comprising a plurality of non-unique elements, a processor to select one or more of said non-unique elements for presentation by a programme content distribution service and a request reception service to receive a request from one of said recipients, determine whether an identifier held by said one recipient comprises a predetermined number of said one or more selected non-unique elements and, in response to a positive determination, allocate a reward to said one recipient.

In a system according to the first or second aspect of the invention, the processor may be further arranged to generate the unique identifiers.

According to a third aspect of the invention, a method of determining whether a recipient of a programme content distribution service is eligible for a reward, comprises receiving an indication of a first unique identifier held by the recipient, obtaining an indication of a second unique identifier presented in conjunction with content transmitted via a programme content distribution system, determining whether the first unique identifier matches the second unique identifier and, in response to a positive determination, notifying the recipient of their eligibility for the reward.

According to a fourth aspect of the invention, a method of determining whether a recipient of a programme content distribution service is eligible for a reward, comprises receiving an indication of a unique identifier held by the recipient, obtaining an indication of one or more non-unique elements presented in conjunction with content transmitted via a programme content distribution system, determining whether the unique identifier includes a predetermined number of said one or more non-unique elements and, in response to a positive determination, notifying the recipient of their eligibility for the reward.

In the methods according to the third and fourth aspects of the invention, the recipient may be notified of their eligibility to claim a reward by text message or e-mail. Moreover, the step of receiving the indication of the unique identifier may comprise providing a form on a web page for completion by the recipient.

Example embodiments of the invention are described hereinbelow with reference to the accompanying drawings, in which:

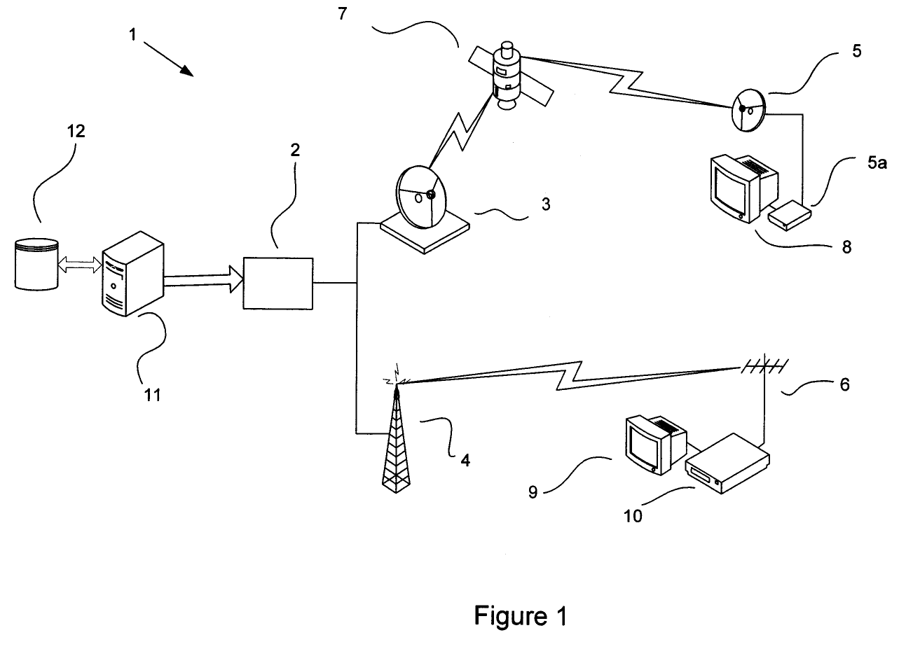

FIG. 1 is a schematic diagram of a system for distributing programming content in which the invention may be implemented;

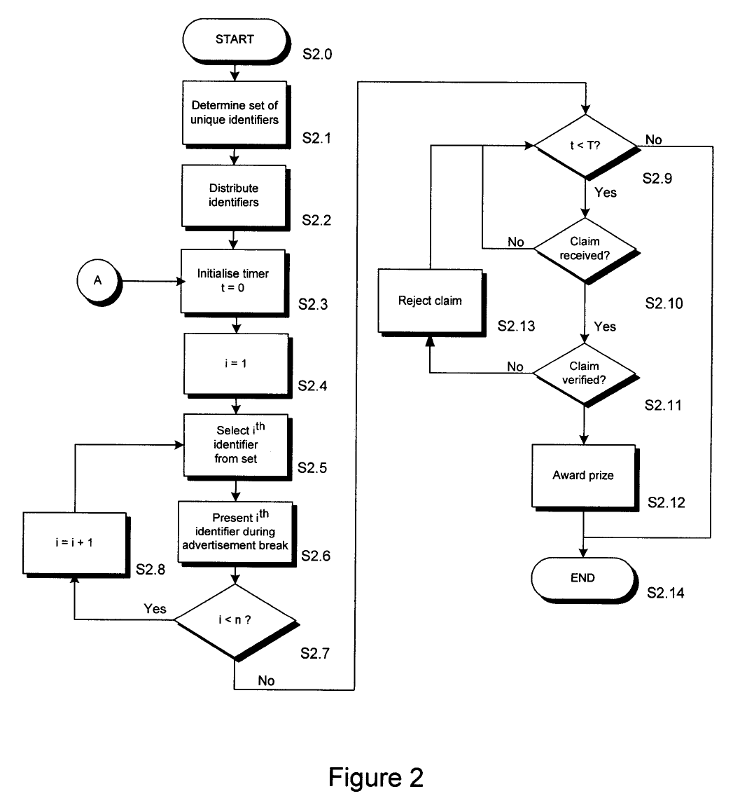

FIG. 2 is a flowchart of a method according to a first embodiment of the present invention;

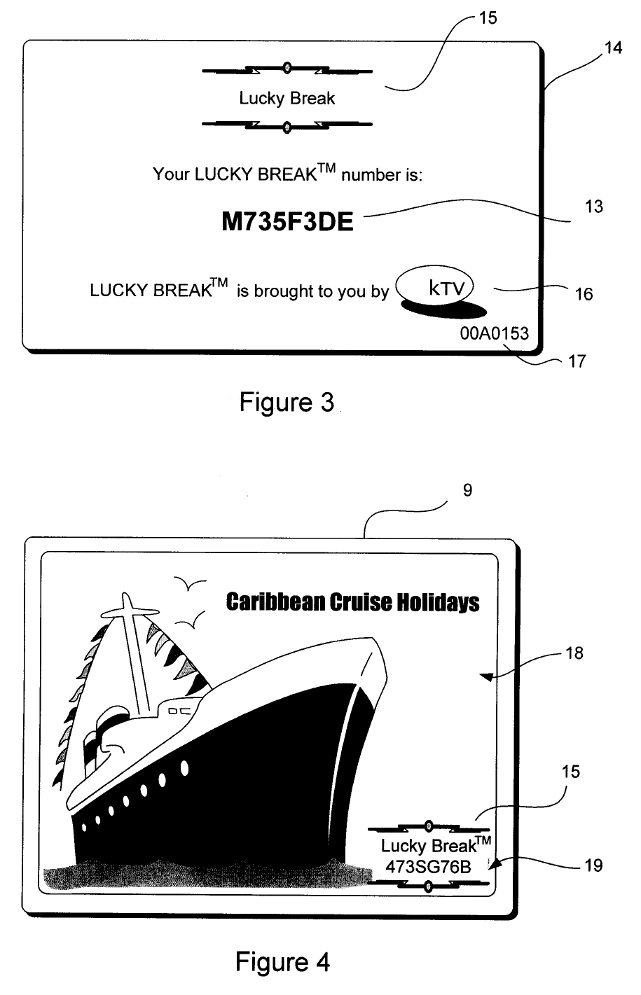

FIG. 3 depicts a card for use in the method of FIG. 2;

FIG. 4 depicts the presentation of a selected identifier during an advertisement, according to the method of FIG. 2;

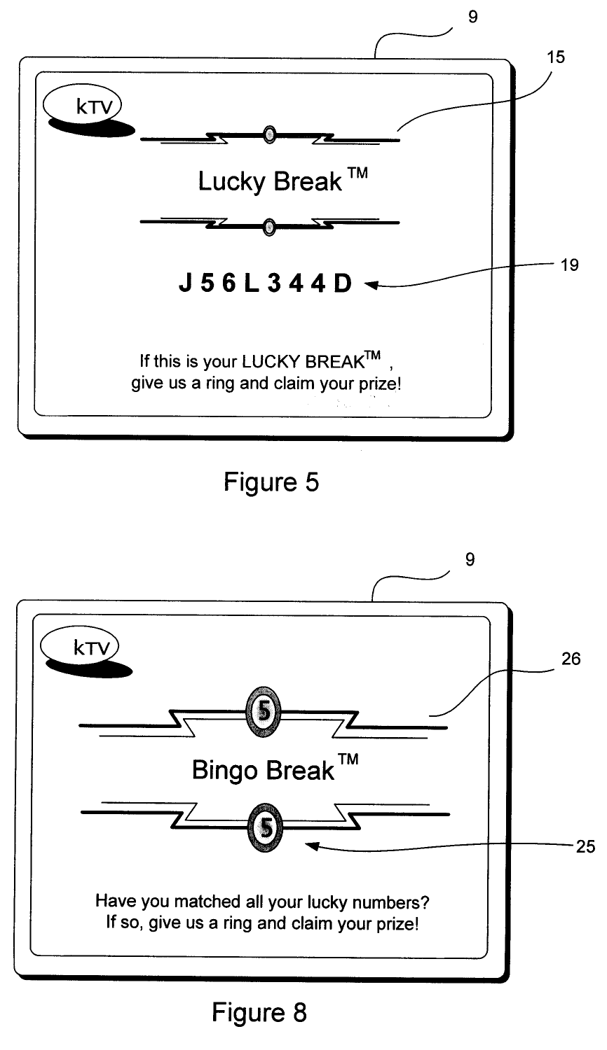

FIG. 5 depicts the presentation of a selected identifier before or after an advertisement, according to the method of FIG. 2;

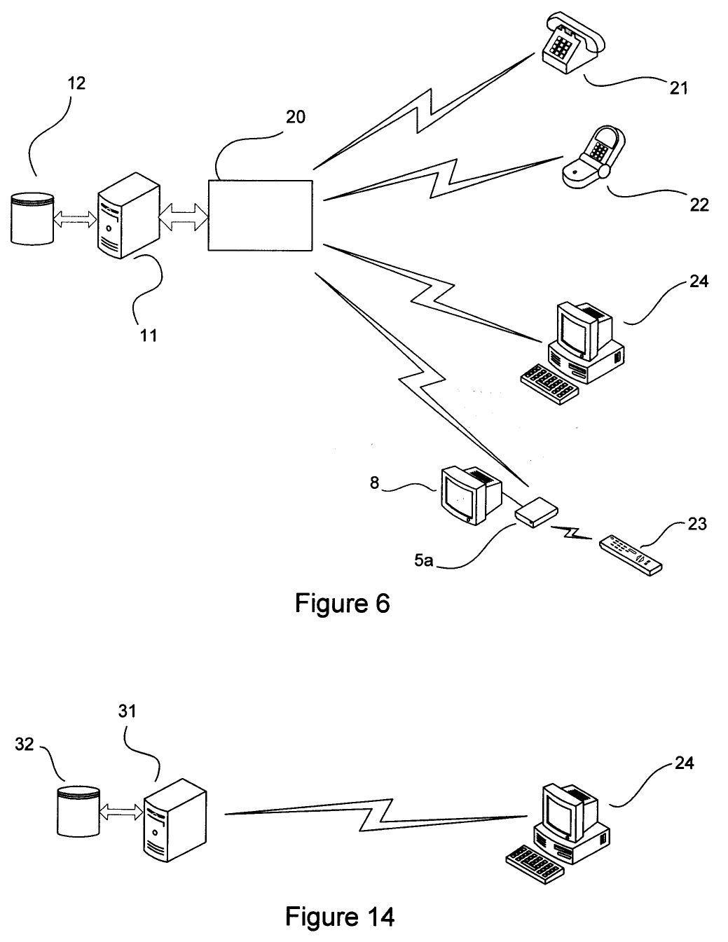

FIG. 6 is a schematic diagram depicting various means through which a viewer can receive an identifier and/or submit a claim in the method of FIG. 2;

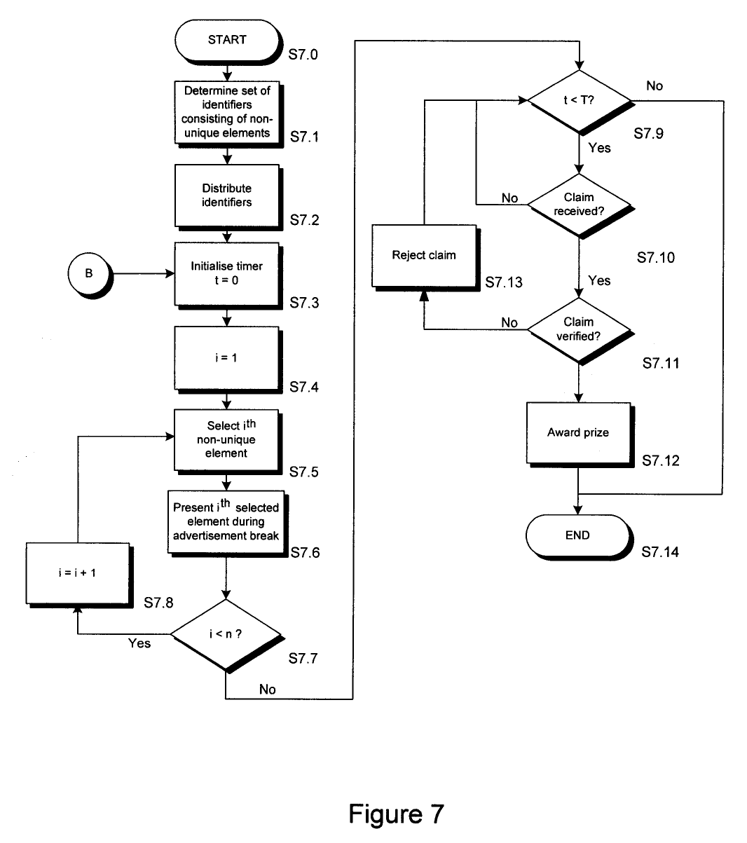

FIG. 7 is a flowchart of a method according to a further embodiment of the present invention;

FIG. 8 depicts the presentation of a selected non-unique element before or after an advertisement, according to the method of FIG. 7;

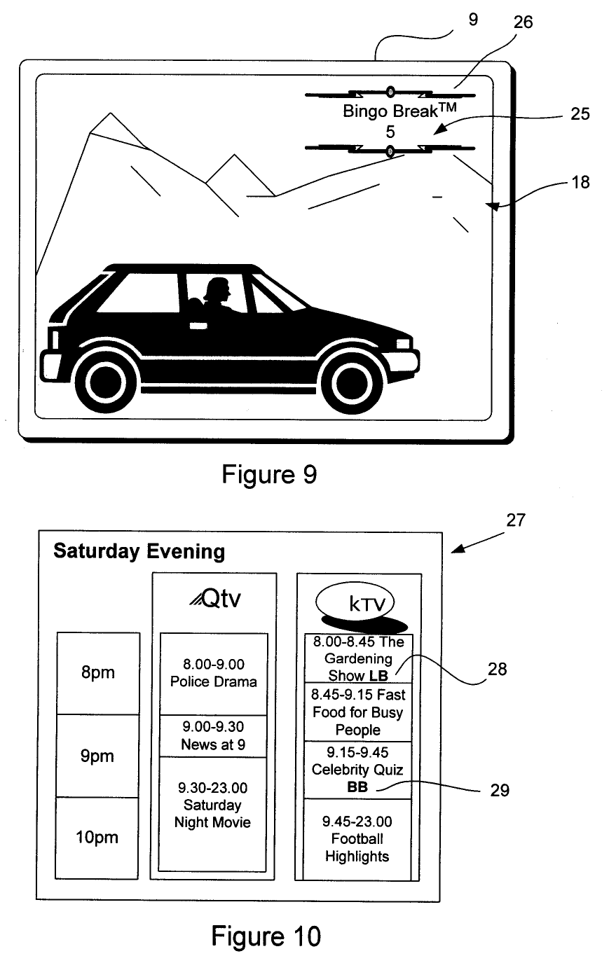

FIG. 9 depicts the presentation of a selected non-unique element during an advertisement, according to the method of FIG. 7;

FIG. 10 depicts a programme listing including information indicating when selected identifiers and/or non-unique elements are to be presented;

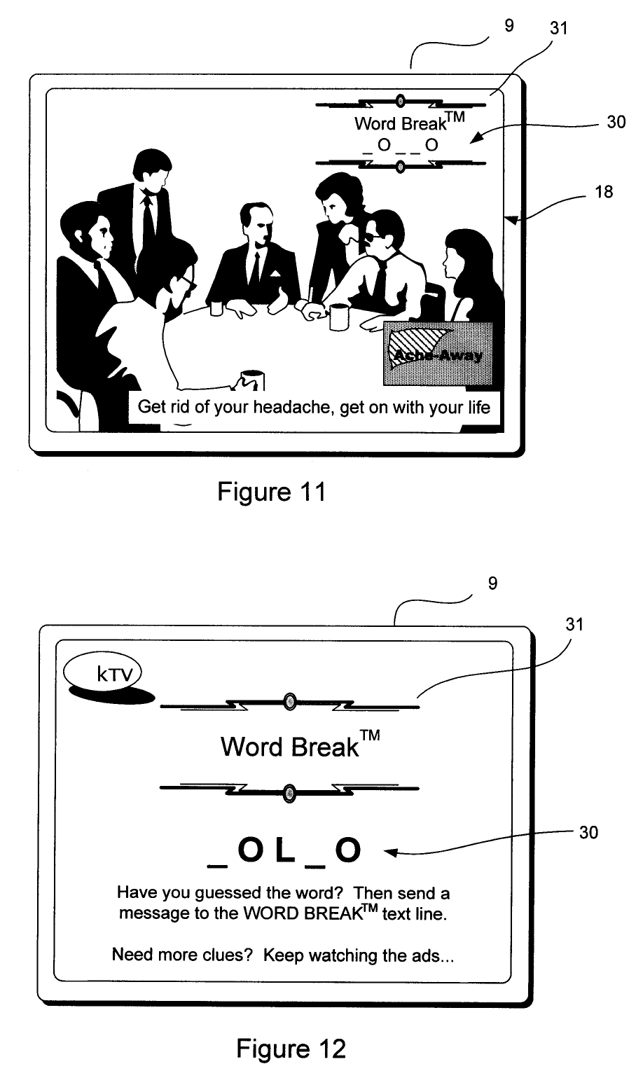

FIG. 11 depicts the presentation of a string comprising blanks during an advertisement;

FIG. 12 depicts a later presentation of the string shown in FIG. 11, wherein one or more of said blanks is replaced with a letter;

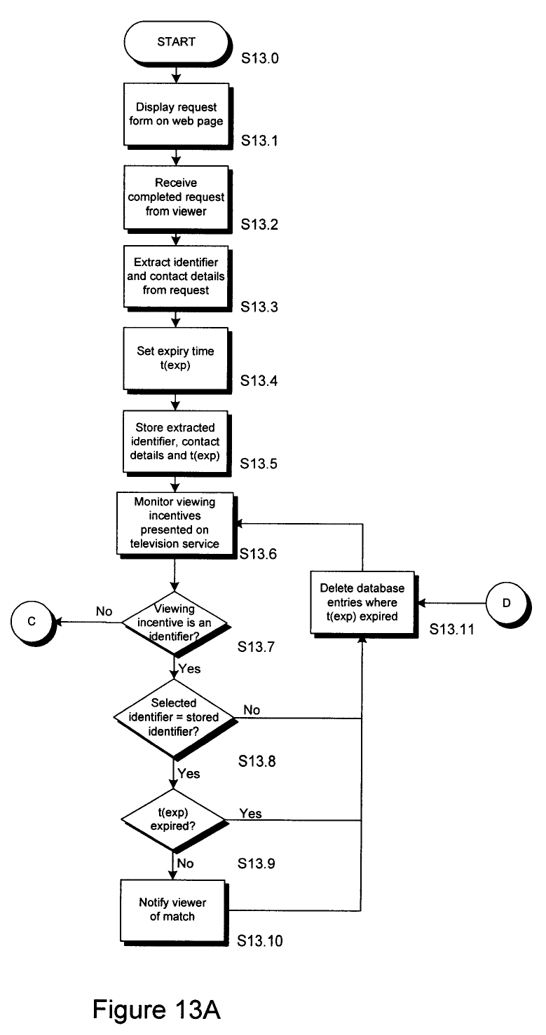

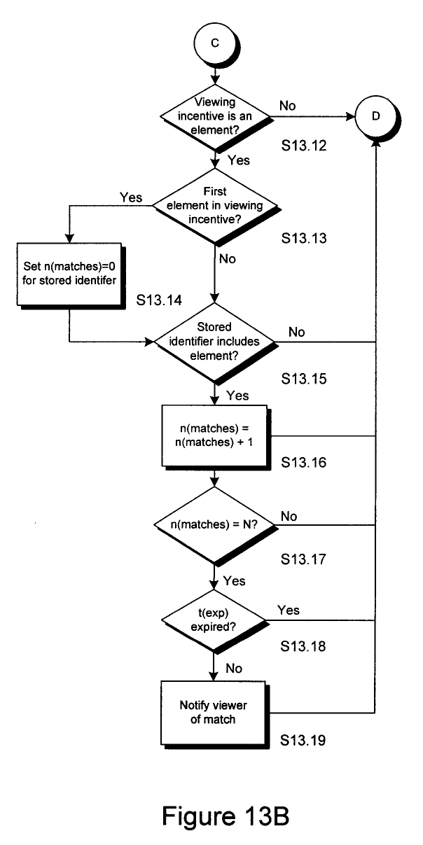

FIGS. 13A and 13B depicts a method of determining whether a viewer is entitled to claim a reward, according to another embodiment of the present invention; and

FIG. 14 depicts a system for performing the method of FIGS. 13A and 13B.

FIG. 1 depicts an example programme content distribution system 1, comprising a source 2 for generating a signal comprising the programme content and transmitters 3, 4 for transmitting the signal to receiving equipment 5, 6. The signal may be an analogue signal or a digital signal.

In this particular example, the programme content distribution system 1 is a broadcast television service. However, the invention may be applied to any other system where content/programming is distributed, via one or more of a variety of technologies such as Internet Protocol Television (IPTV), broadcast television, video on demand, Universal Mobile Telecommunication System (UMTS), Digital Video Broadcasting-Handheld (DVB-H), Digital Audio Broadcast (DAB), etc. using any number of platforms such as cable, satellite, ADSL, fibre, wireless, terrestrial, etc. In the following, users receiving the service are referred to as viewers. However, the term viewers is intended to include listeners in embodiments where the programme content distribution system 1 provides only an audio service, such as a radio service.

In the system 1 of FIG. 1, the transmitter 3 transmits the signal to a satellite 7, which broadcasts the signal within its area of coverage, or cell. The signal can be received by a satellite dish 5, processed by a set-top box 5a and viewed on display equipment, such as a television 8. Meanwhile, the signal broadcast by transmitter 4 is received by a terrestrial aerial 6 and presented to a viewer by display equipment, television 9 or stored on a recordable medium, such as a hard drive, video cassette or digital versatile disc (DVD), by recording equipment 10.

In addition to distributing programme content, the system 1 also distributes promotional material during breaks in the programme content. In this example, the promotional material is in the form of advertisements, which may be broadcast in a series, known as a commercial break, and/or sponsorship advertisements, which appear immediately before and after a programme and at the start and end of commercial breaks during that programme.

FIG. 2 is a flowchart of a method according to a first embodiment of the invention, which can be implemented in the television system of FIG. 1.

Starting at step s2.0, a plurality of unique identifiers are determined (step s2.1). The unique identifiers may take the form of a random number, a string of letters or a string of letters and numbers, and, in this example, are generated by a processor 11, shown in FIG. 1. The use of letters instead of, or in addition to, numbers permits the generation of a larger number of unique strings with a given length, when compared with the use of numbers alone. If desired, symbols may be included in the identifiers instead of, or in addition to, numbers or letters. The set of unique identifiers is stored in a database 12.

The unique identifiers are then distributed to potential viewers of the television service (step s2.2). One or more identifiers 13 may be provided on a card 14, as shown in FIG. 3, which is distributed to households by hand or by mail.

The card 14 may also include information identifying the purpose of the card 14, such as a logo bearing a motif 15 such as “Lucky Break”™. The card 14 may also include information identifying the channel or system over which identifiers will be transmitted, such as a broadcaster's logo 16 and, optionally, an identification code 17. The identification code 17 is different for each card 14, and will be described later.

The card 14 may also include instructions for submitting claims when the identifier 13 corresponds to an identifier presented during a commercial break. For example, this may take the form of a telephone number for a designated call centre, not shown, printed on the back of the card 14. The identifier 13 of each card 14 and, if provided, the corresponding identification code 17, may be stored in the database 12, shown in FIG. 1, along with details of the household to which the card was sent, such as a postal address.

In this particular embodiment, the card 14 has the dimensions of a credit card and is made of plastic, so that it is convenient for a viewer to carry their card 14 at all times.

The identifiers 13 may be distributed electronically instead of, or in addition to, using printed material such as the cards 14. For example, the identifiers 13 may be sent to viewers using a text message sent to mobile telephones 22, shown in FIG. 6, and/or other text enabled fixed telephones or by e-mail to a computer 24 or other e-mail enabled communication device. The text message could include information regarding the purpose of the identifier 13 and/or the procedure for claiming prizes. The text message may also include an identification code 17. However, where the text message is sent to a telephone 22, the telephone number may be used in place of the identification code 17 and can thus be omitted.

The use of text messages to distribute the identifiers 13 may be particularly advantageous where the communication devices can be used to present television content to a user. For example, the communication devices may be Third Generation (3G) mobile telephones.

The step of distributing the identifiers 13 may also include sending instructions regarding the use of the identifiers 13, as will be described below, and/or suitable marketing, to alert viewers to the purpose of the identifiers 13, in advance of their distribution.

Not all of the identifiers in the set generated in step s2.1 may be distributed in step s2.2. The proportion of identifiers 13 that are distributed can be set so that the likelihood of a match between a selected identifier and an identifier 13 provided on a card 14 is within a predetermined range.

A number of identifiers selected from the set of unique identifiers determined in step s2.1 are then transmitted in conjunction with advertisements, as will now be described.

When selected ones of the identifiers are to be transmitted, a timer is initialised (step s2.3). The timer is used to enforce a limited period T for receiving claims for prizes arising from the display of the selected identifiers. In this particular example, the predetermined time period T is one hour, in order to maximise live viewing. However, a longer window could be allowed in order to allow recorded programming to be played back and claims submitted if desired by the broadcaster and advertiser.

A first identifier is then selected from the set (steps s2.4, s2.5). For example, the first identifier may be selected at random from the set of identifiers held on the database 12.

In this embodiment, the source 2 generates the signal to include the first selected identifier so that, when presented on a display, the first selected identifier is superimposed over an advertisement (step s2.6). FIG. 4 depicts an image displayed on the television 9 as a result of this step, which includes the advertisement, generally indicated by 18, over which the first selected identifier 19 is superimposed. The motif 15 may also be presented.

In order to induce viewers to watch a significant portion of a given advertisement 18, or of the commercial break, it is preferable for the first selected identifier 19 to be displayed for a limited period only and not for the duration of the commercial break. This also encourages the viewer to focus their attention on the advertisements 18. If the identifier 19 is displayed for a limited time, say, towards the end of an advertisement 18, the viewer's attention is not distracted away from advertisement 18 itself.

Alternatively, the source 2 may generate the signal so that the selected identifier 19 and, if required, the motif 15, are presented before, after or between advertisements in a “stand alone” manner, as shown in FIG. 5. This ensures that the attention of the viewer is not distracted from the advertisements by the presentation of the selected identifier 19.

If further identifiers are to be presented to the viewers (steps s2.7, s2.8), a next one of the identifiers in the set stored in the database 12 is selected (step s2.5) and presented (step s2.6). Steps s2.5 to s2.8 are repeated until a desired number n of selected identifiers have been presented, where n is greater than or equal to one.

In this embodiment, the next identifier is selected at random from the set of identifiers. Thus, it is possible for a single identifier to be selected, and presented, more than once. Alternatively, a subset of the set of identifiers may be selected prior to transmission and presented in a random order.

If no further identifiers are to be presented (step s2.7), for example, if the transmission of the commercial break is complete, the processor 11 waits for claims from viewers to be received, until the expiry of the predetermined time period T (step s2.9).

The claims may be submitted by a viewer contacting a request reception service, such as a designated call centre 20 shown in FIG. 6, by telephone 21, 22 using a voice call or, if preferred, a text message. The telephone number for the call centre may be provided on the card 14, or advertised elsewhere. If the television service is interactive, such as a digital interactive television system, the viewer may submit their claim via the television service, for example, by pressing a designated button on a remote control 23 or other suitable device.

Alternatively, or additionally, a viewer may be able to submit a claim by accessing a web page using a personal computer 24 or a WAP (Wireless Application Protocol) deck using a WAP-enabled telephone 22. The web page or WAP deck may provide a form in which the viewer can submit the relevant details for their claim and send them to the call centre 20. The Universal Resource Locator (URL) of the web page or WAP deck may be indicated on the card 14 and/or advertisements elsewhere.

If, before the predetermined time period T has expired (step s2.9), a claim is received (step s2.10), the claim is verified (step s2.11) by checking that the identifier 13 held by the viewer matches one of the selected identifiers 19 or, where several identifiers have been presented, one of the selected identifiers 19 displayed during the commercial break. If the identifiers have been distributed using cards 14, the claim may be verified by determining whether the identification code 17 provided on the card 14 held by the viewer matches the identification code 17 corresponding to the selected identifier 19 held on the database 12 and/or by matching the information relating to the household to which the relevant card 14 was sent with the household information stored on the database 12.

If the claim is verified (step s2.11), the viewer is awarded a prize (step s2.12). If not, the claim is rejected (step s2.13) and the processor 11 waits for any further claims to be received during the predetermined time period T (step s2.9).

If there are no further claims before the time period T expires (step s2.9), or if no claims at all are received during the time period T, the process ends (step s2.14). The latter case may arise when a viewer holding a card 14 with an identifier 13 matching one of the one or more selected identifiers 19 is not aware of the match or where the selected identifiers 19 correspond to identifiers that were not distributed to households or viewers.

The database 12 of identifiers 13 can be maintained so that the procedure of presenting selected identifiers 19 and awarding prizes for matches (steps s2.3 to s2.23) can be repeated, without requiring the determination or distribution of new identifiers (steps s2.1, s2.2). In other words, identifiers 19 can be presented during other commercial breaks using a procedure starting at point A in FIG. 2. By removing the need for new identifiers 13 and cards 14, the cost of repeating the procedure is reduced considerably.

The steps of determining the set of unique identifiers, which may include generating the unique identifiers, selecting an identifier and verifying a claim may be automated using the processor 11 and request reception service 20. The verification process performed by the request reception service may utilise the database 12 and, optionally, the processor 11.

In the method of FIG. 2, the unique identifiers 13 are generated by the processor 11 and distributed to potential viewers. In another embodiment, the unique identifiers are selected from a set of pre-existing identifiers associated with households or with potential viewers. For example, the identifiers may be selected from a set of viewing card numbers, customer reference numbers from utility services or from loyalty programmes or telephone numbers, relating to fixed and/or mobile telephones stored in the database 12. In the case where telephone numbers are used as the identifiers 13, the viewer may be automatically sent a prize in response to their claim, the prize being sent to the address associated with the selected telephone number. Alternatively, the viewer may be required to claim their prize by calling the designated call centre 20 from a telephone corresponding to that telephone number. In that case, the claim may be verified by matching the Caller Line Identification of the viewer's telephone with one of the selected telephone numbers. Such a method avoids the cost of manufacturing and distributing cards 14. Furthermore, as well as increasing the reach and effectiveness of the advertisements transmitted by the programme content distribution service, such a method can potentially benefit one or more telephone, pay TV, utility or other companies in terms of brand awareness, customer retention and revenue as viewers have to be customers in order to participate.

FIG. 7 depicts a method according to a further embodiment of the invention, that may also be implemented in the programme content distribution system 1 of FIG. 1.

Starting at step s7.0, a set of unique identifiers is generated by processor 11 (step s7.1) and stored on the database 12, as described above in relation to step s2.1 of FIG. 2. The identifiers comprise a string of non-unique elements, such as numbers, letters and/or symbols. The set of elements are stored in the database 12. The identifiers 13 are then distributed (step s7.2), as described above in relation to step s2.2 of FIG. 2, using a card 14 as shown in FIG. 3. If required, a Lucky Break”™ motif 15, a broadcaster logo 16 and/or an identification code 17 may also be included. The identifier 13 and, if required, the identification code 17 and information regarding the household to which the card 14 has been sent, is stored in the database 12.

A timer is initialised (step s7.3), for use in determining whether a predetermined period T for receiving claims has elapsed.

A first one of the non-unique elements of the identifiers 13 is then selected (steps s7.4, s7.5) and presented (step s7.6). The source 2 generates the signal so that, when viewed on a display equipment, such as a mobile phone, PDA or television 9, the first selected element 25 is presented either alone, as shown in FIG. 8, or superimposed over an advertisement 18, as depicted in FIG. 9. The selected element 25 is presented for a limited period. In this embodiment, a designated motif 26, such as “Bingo Break™” is used to indicate that elements 25, rather than full identifiers 13, are being presented.

The next element to be presented is then selected (steps s7.7, s7.5) and presented (step s7.6). The next selected element may be displayed immediately after the first selected element 25, after a predetermined time interval, before, during or after a subsequent advertisement 18 or during a subsequent commercial break. Steps s7.5 to s7.8 are repeated until a desired number n of the non-unique elements 25 has been presented, where n is greater than, or equal to, the number of elements contained in an identifier 13.

When n elements 25 have been presented (step s7.8), the processor 11 waits for claims from viewers to be received, until the expiry of the predetermined time period T (step s7.9). The procedure for checking claims received during the predetermined time period T (steps s7.9 to s7.14) is as described above in relation to steps s2.9 to s2.14 of FIG. 2 except that, in this case, the viewer must hold a card 14 in which the identifier 13 includes a predetermined number of the selected elements 25 that have been presented. More than one viewer may be awarded a prize.

As described above in relation to the method of FIG. 2, the procedure for selecting and transmitting non-unique elements 25 can be performed again without requiring the determination and distribution of new identifiers 13. In this case, the method begins at point B, with the initialisation of the timer (step s7.3).

While the method of FIG. 7 has been described in relation to identifiers 13 that have been generated specifically for this purpose, the identifiers may instead be selected from a set of pre-existing identifiers associated with households or with potential viewers. For example, the selected identifiers 19 may be telephone numbers, as described above in relation to FIG. 2.

Although the methods of FIG. 2 and FIG. 7 have been described separately, they may be used in combination. For example, the method of FIG. 2 may be performed, followed by a repetition of the method of FIG. 2, starting at point A, or the method of FIG. 7, starting at point B, and so on. Similarly, the method of FIG. 7 may be performed and followed by the method of FIG. 2, starting at point A, or a repetition of the method of FIG. 7, starting at point B, and so on. In this manner, the methods of FIG. 2 and FIG. 7 may both be employed in providing incentives for viewers to watch a plurality of commercial breaks, without requiring the determination and/or distribution of new identifiers 13 and/or cards 14.

Preferably, the identifiers 19 and/or elements 25 are transmitted during peak viewing times. In any case, the broadcaster can expect to receive higher advertising revenues as a result of the said methods increasing both the volume of advertising impacts and premium rates due to the commercials greater reach and effectiveness. The broadcaster using the said invention could also expect to gain audience and hence advertising share. In order to promote a given programme, the identifiers 19 or elements 25 may be transmitted during commercial breaks before, during and/or after a particular show.

In the above embodiments, the prizes are awarded to viewers on a rolling basis, in order to maintain their interest. However, the method may be implemented so that there is always a top prize of, say, US $100,000 that can be awarded, although the average pay out per week may be lower, or higher, than this figure.

Advertisers may also sponsor the prizes to be awarded to their viewers, in return for a selected identifier 19 or elements 25 being displayed during their advertisement. The prizes may take the form of cash or their own products. For example, a travel company could offer a holiday prize, while a vehicle manufacturer could offer a car.

The identifiers 19 and/or elements 25 can be presented to indicate the type of prize on offer. For example, a cash prize may be indicated using a designated motif, such as “Cash Break™” or “Money Break™”, in place of, or as well as, the “Lucky Break™” motif 15, while a product prize may be indicated using a motif such as “Product Break™”. Where the prize is sports related, such as sports memorabilia, a trip or ticket to a sporting event, a motif such as “Sports Break™” can be used. Alternatively, or additionally, the identifiers 19 or elements 25 in a colour associated with the type of prize. For example, a cash prize may be indicated by displaying an identifier 19 or elements 25 using a gold colour, a product prize indicated by presentation of an identifier 19 or elements 25 in a blue colour and other types of prizes are indicated using different colours.

The commercial breaks during which the selected identifiers 19 and/or elements 25 are to be presented can be indicated to potential viewers in advance of their transmission. FIG. 10 depicts a programme listing 27 of the type found in Electronic Programme Guides (EPGs), newspapers, magazines, webpages or teletext. The listing 27 includes an indication of when the selected identifiers 19 or elements 25 will be presented. In the example shown in FIG. 10, selected identifiers 19 are presented during one or more commercial breaks in a first programme “The Gardening Show”. This is indicated by a label 28 “LB”, which stands for “Lucky Break™”, included in the programme listing 27. Alternatively, the indication may be in the form of a statement in the listing 27, such as “This show will include a Lucky Break™”. During a later programme, “Celebrity Quiz”, on the same channel, selected non-unique elements 25 of the identifiers will be presented as indicated by a label 29 “BB”, which stands for “Bingo Break™”. The opportunity to win other types of prizes may be indicated using different statements or indications, such as “£B” for a “Cash Break™”, “PB” for a “Product Break™” or “SB” for a “Sports Break™”.

The pay out probability, in terms of the number and sizes of the prizes, can be set to ensure a return for the television service and/or advertiser.

In the above embodiments, the cards 14 are distributed to households by hand or by mail. Alternatively, or additionally, cards 14 can be included as inserts in a newspaper or magazine. For example, if selected identifiers 19 or elements 25 are to be presented in a commercial break during the broadcast of a soap opera, the cards 14 may be distributed as inserts to a magazine devoted to such programmes. The card may also include an indication of a programme or time of a commercial break during which the selected identifiers or elements are to be broadcast. The system 1 of FIG. 1 can also be used to provide other incentives for viewers to watch commercial breaks by allocating prizes to one or more viewers who send a response to information presented in conjunction with the advertisements, as will now be described.

A “Word Break™” may be presented, in which letters in a selected word are presented during a commercial break. For example, as shown in FIG. 11, a string 30 with one or more blanks, in place of letters, can be presented, together with an appropriate motif 31. The string may be presented during an advertisement 18 or in a “stand-alone” manner during a commercial break. If required, the string 30 could be presented again with one or more letters filled in, as shown in FIG. 12, either during a subsequent advertisement and/or during a later commercial break. In one embodiment, the various letters of the string 30 are filled in during a single commercial break, in other words, within a single sequence of commercials.

The string 30 presented during the “Word Break” may be linked with an advertiser, such as a brand name or a product name and/or linked with the type of prize on offer with the advert appearing at the end of the commercial break with the completed string. In the example shown in FIGS. 11 and 12, the string is a single word “VOLVO”.

A reward can be allocated to the first viewer who correctly responds to the presented information. A viewer identifying the string 30 can then send a text message including the completed string to the call centre 20. One or more correct responses are selected. The call centre 20 sends a second message, such as a text message, to the viewers who have sent the selected responses. The second message includes a temporary identifier. This temporary identifier is unrelated to the “Lucky Break” identifier 13 on the viewer's card 14. The viewer is then required to contact the call centre 20 within a specified time period T, for example, within one hour, the time period T being monitored by a timer, as described above in relation to the methods of FIG. 2 and FIG. 7.

The viewer contacting the call centre 20 must then quote the temporary identifier, together with the identifier 13 and/or identification code 17 on their card 14. A prize is then sent to the viewer, based on address information stored in the database 12 corresponding to the quoted identifier 13 and/or identification code 17. If required, prizes may be awarded to the addresses of a predetermined number of viewers who correctly identify the string.

In the above example, the viewer responds to the “Word Break” using a text message. However, the system 1 may be arranged so that other methods of sending messages to the call centre 20 may be used, such as filling in a form on a web page or sending an e-mail, using a personal computer 24, a voice call and so on.

In another example, a “Question Break™” is used, in which a question requiring a response is presented during a commercial break. The question is either superimposed over the advertisements or presented in a “stand-alone” manner. If required, the question may relate to advertised products and/or to information in the advertisements themselves, such as how many flavours of a particular product are available, in order to encourage viewers to pay close attention to the advertisements. A viewer may then send a message to the call centre 20, using a text message or the other methods described above in relation to the “Word Break”, submitting their answer to the question. One or more viewers submitting correct answers are then sent a second message, which includes a temporary identifier. If the one or more viewers contact the call centre 20 within a specified time period T, quoting their identifier 13 and/or identification code 17 from their card 14, they are awarded a prize.

In a further example, a “Name Break™” may be used. Here, a name is presented during a commercial break. A viewer having that name may then respond by sending a message to the call centre 20 and, if selected, will receive a second message including a temporary identifier. The selected viewer, or viewers, may then claim a prize by contacting the call centre 20 and quoting their temporary identifier, together with the identifier 13 and/or identification code 17 from their card 14. If name information is stored in the database 12, the viewer's claim can be verified by checking that the name information corresponding to the identifier 13 and/or identification code 17 provided by the viewer matches the name presented during the “Name Break”.

As discussed above in relation to FIG. 10, the transmission of a “Word Break”, “Question Break” or “Name Break” during a television programme may be indicated in a programme listing 27.

Variations of the “Question Break”, “Word Break” and “Name Break” described above will now be described.

In one example variation, the viewer may be required to include their identifier 13 and/or identification code 17 in the message sent to the call centre 20 in response to a “Question Break”, “Word Break” or “Name Break”, as well as any required string or answer. In such a variation, a prize may be sent automatically to an address stored in the database 12, corresponding to the viewer's identifier 13 and/or identification code 17, without requiring the sending of a second message with a temporary identifier.

In another variation, a number of viewers who have responded correctly to the “Word Break”, “Question Break” or “Name Break”. One or more temporary identifiers may be then be selected from those distributed to those viewers. The one or more selected temporary identifiers are then broadcast during a subsequent commercial break, either superimposed over an advertisement or presented in a “stand-alone” manner. The one or more viewers having a second message containing the selected identifier can then claim a prize by contacting the call centre 20 and quoting the identifier 13 and/or identification code 17 on their card 14. For example, the first 1000 viewers to text in their answer may receive a text message containing a number between 0-1000. A number from 0-1000 is then selected at random and displayed at the beginning of the next commercial break. The viewer with the matching temporary identifier is then allocated a prize which can be claimed by contacting the call centre 20 and quoting the identifier 13 on their card 14. This method has the advantage that a viewer responding to the “Word Break”, “Question Break” or “Name Break” is provided with an incentive to watch a further sequence of advertisements, in order to determine whether they can claim a prize.

Alternatively, or additionally, identifiers 13 may be distributed to viewers who submit correct responses to a “Word Break”, “Question Break” or “Name Break”, in place of the temporary identifiers. This distribution method may be used as well as, or instead of, cards 14 or the electronic distribution methods described above in relation to FIG. 2.

In yet further variations, one or more of “Word Break”, “Question Break” and “Name Break” can be operated as stand alone methods, separate from the method shown in FIGS. 2 and/or 7, without the need for viewers to have a previously received unique identifier. In such methods, successful viewers can contact a stand alone call centre via any of the methods depicted in FIG. 6 and give their name and address details in order to receive the viewing incentive.

In the above described embodiments, selected identifiers 19 or selected non-unique elements 25 of identifiers are presented in conjunction with promotional material. However, such identifiers 19 or non-unique elements 25 could, alternatively or additionally, be presented during programme content, in order to provide viewers with an incentive to watch a particular television programme.

A service allowing a viewer to check their eligibility for a prize based on the viewing incentive may be provided, as will now be described with reference to FIGS. 13A and 13B and 14. Such a service may be provided in order to allow a viewer unable to view particular programme content, due to other commitments, to check whether they are eligible for a prize.

In this particular embodiment, the viewer can access the service via a web page using a computer 24. Starting at step s13.0, when a viewer accesses the service, a server 31 displays a web page comprising a request form (step s13.1). The viewer can then complete the form by entering their unique identifier 13 and their contact details. If the service is provided for a one-off fee or subscription, the viewer must also provide payment details, such as a credit card number. The information provided by the user is then received by the server 31 (step s13.2). If required, the information can be encrypted before being sent to the server 31.

The server 31 then extracts the identifier 13 and contact details from the request (step 13.3). Where the service is provided for a set period of time, such as a week, a month or longer, or on a periodic subscription basis, an expiry time t(exp) is set (step 13.4), which indicates a time at which the viewer's use of the service is due to cease. The identifier 13, contact details and t(exp) for that viewer is then stored in a database 32 (step s 13.5).

The viewing incentives presented by the programme content distribution service 1 are then monitored (step s13.6).

When a viewing incentive is displayed, it is determined whether the viewing incentive is a selected identifier 19 (step s13.7), as shown in the examples of FIGS. 4 and 5. If a selected identifier 19 has been displayed, the server 31 determines whether the selected identifier 19 matches any of the identifiers stored in the database 32 (step s13.8).

If a match is found, the server check whether the viewer holding the matching identifier 13 still has access to the service, by determining whether the expiry time t(exp) corresponding to their identifier 13 has passed (step s 13.9).

If the expiry time t(exp) has not yet passed, the viewer is notified of the match (step s13.10), using the contact details that they have provided. The method used to notify the viewer will depend on the contact details they have provided and any preference between alternative contact methods indicated on their request form. Suitable contact methods include text messaging, if the viewer has provided a mobile telephone number, e-mail, if an e-mail address has been given, or an automated telephone call.

If it is found that the expiry time t(exp) has passed (step s13.9) or that there are no matches (step s13.8), the server 31 updates the database 32 to remove any entries for which the expiry time t(exp) has passed and the monitoring of viewing incentives presented on the television service continues (step s13.6).

If it is found that the viewing incentive is not a selected identifier 19 (step s13.8), it is determined whether the viewing incentive is a selected non-unique element 25 of an identifier (step s13.12), as in the examples shown in FIGS. 8 and 9.

If the viewing incentive is a selected non-unique element 25 (step s13.12), the server 31 determines whether the selected non-unique element 25 is the first element 25 presented in a particular viewing incentive (step s13.13). For example, for the examples shown in FIGS. 8 and 9, the server 31 would determine whether the displayed non-unique element 25 “5” was the first non-unique element in a given “Bingo Break” competition.

If the selected non-unique element 25 is the first element presented in a viewing incentive (step s13.13), the server 31 sets a parameter n(matches) for each stored identifier 13 (step s 13.14). The parameter n(matches) is used to indicate the number of selected non-unique elements 25 displayed by the programme content distribution service 1 that are included in each identifier 13.

The server then determines which of the stored identifiers 13 include the selected non-unique element 25 (step s13.15).

Where a match is found (step s13.15), the server 31 increments n(matches) for the relevant identifier 13 by one (step s13.16) and checks whether n(matches) has reached the predetermined number of matches N required in order to claim a prize (step s13.17). If n(matches) is equal to the predetermined number N, the server checks whether the expiry time t(exp) corresponding the identifier 13 has expired (step s13.18). If the expiry time t(exp) has not passed (step s13.18), the relevant viewer is notified of their eligibility for a prize (step s13.19), as described above in relation to step s13.10.

The server 31 then updates the database 32 by deleting entries for which the expiry time t(exp) has passed (step s13.11). The monitoring of viewing incentives then continues (step s13.6).

If it is determined that further elements in the viewing incentive are presented (steps s13.7, s13.12, s13.13), the checking procedure of steps s13.15 to s13.19 is repeated.

If it is determined that the presented viewing incentive is neither a selected identifier 19 nor a selected non-unique element 25 (steps s13.7, s13.12), it is presumed that the viewing incentive is one that requires input from the viewer, such as a “Question Break” or “Word Break”. The server 31 then updates the database by deleting expired entries (step s13.11) and the monitoring of viewing incentives continues (step s13.6).

Although not shown in FIGS. 13A and 13B, the service may also be arranged to check whether a viewer is eligible for a prize following a “Name Break”, by comparing the name provided in the viewer's contact details with a name presented on the programme content distribution service 1 and to notify the viewer if a match is found.

Although, in the above described embodiment, the viewer accesses the service by submitting a request form via a web page, the service may be arranged to accept requests through other means, such as an e-mail, text message or manual input based on a postal request.

The service may be provided using the processor 11 of the programme content distribution system 1 to perform the checking and notification procedures and the database 12 for storing the expiry time t(exp) and other parameters such as n(matches), in place of the server 31 and database 32 shown in FIG. 14.

1. A method of providing an incentive to receive content transmitted via a programme content distribution service, comprising:
determining a plurality of unique identifiers;
transmitting content and a selected one of said unique identifiers via the programme content distribution service so that said selected unique identifier is presented to recipients of the programme content distribution service in conjunction with said content; and
in response to a request from one of said recipients, determining whether an identifier held by said one recipient matches said selected unique identifier and, in response to a positive determination, allocating a reward to said one recipient.

2. A method according to claim 1, wherein:
said step of transmitting content comprises transmitting programme content and transmitting one or more instances of promotional material during breaks in said programme content; and
said selected unique identifier is transmitted during at least one of said breaks in said programme content.

3. A method according to claim 2, wherein said step of transmitting said selected unique identifier comprises presenting the selected unique identifier for a limited period of time during one of said instances of promotional material.

4. A method according to claim 2, comprising displaying a series of unique identifiers during a sequence of instances of promotional material.

5. A method according to claim 1, wherein:
said step of transmitting content comprises transmitting programme content; and
said selected unique identifier is transmitted in conjunction with said programme content.

6. A method according to claim 1, wherein said content comprises images and, when the content is viewed on a display equipment, said selected unique identifier is superimposed onto said images.

7. A method according to claim 2, wherein said transmission of the selected unique identifier during said break in programme content occurs before or after the transmission of one of said one or more instances of promotional material within said break in programme content.

8. A method according to claim 1, wherein:
said reward is allocated only if said request is received within a predetermined time period from the transmission of said selected unique identifier.

9. A method according to claim 1, wherein each of said unique identifiers consists of a plurality of non-unique elements, comprising:
a plurality of steps of transmitting one or more selected ones of said non-unique elements; and
in response to a request from one of said recipients of said programme content distribution service, determining whether the unique identifier held by said one recipient includes a predetermined number of said selected non-unique elements and, in response to a positive determination, allocating a reward to said one recipient.

10. A method of providing an incentive to receive content, comprising:
determining a plurality of unique identifiers, wherein each of said unique identifiers consists of a plurality of non-unique elements;
transmitting content and at least one selected non-unique element via a programme content distribution service; so that said at least one selected non-unique element is presented to recipients of the programme content distribution service in conjunction with said content; and
in response to a request from one of said recipients, determining whether a unique identifier held by said one recipient includes a predetermined number of said at least one selected non-unique elements and, in response to a positive determination, allocating a reward to said one recipient.

11. A method according to claim 10, wherein:
said step of transmitting content comprises transmitting programme content and transmitting one or more instances of promotional material during breaks in said programme content; and
said step of transmitting at least one selected non-unique element comprises one or more steps of transmitting at least one selected non-unique element during at least one of said breaks in said programme content.

12. A method according to claim 10, wherein said step of transmitting said selected non-unique element comprises presenting the selected non-unique element for a limited period of time during one of said instances of promotional material.

13. A method according to claim 10, comprising displaying a series of non-unique elements during a sequence of instances of promotional material.

14. A method according to claim 10, wherein said step of transmitting content comprises transmitting programme content; and
said at least one selected non-unique element is transmitted in conjunction with said programme content.

15. A method according to claim 10, wherein the content comprises images and, when viewed on a display equipment, said at least one of said selected non-unique elements is superimposed onto said images.

16. A method according to claim 11, wherein said transmission of said at least one of said selected non-unique elements occurs before or after the transmission of one of said one or more instances of promotional material within said break in programme content.

17. A method according to claim 10, wherein:
said reward is allocated only if said request is received within a predetermined time period from the transmission of one of said selected non-unique elements.

18. A method according to claim 4, wherein said sequence is a series of advertisements.

19. A method according to claim 1, wherein said step of determining a plurality of unique identifiers comprises generating a set of unique identifiers.

20. A method according to claim 1, wherein said step of determining a plurality of unique identifiers comprises obtaining pre-existing unique identifiers from a data source.

21. A method according to claim 1, comprising distributing the unique identifiers to potential recipients of the programme content distribution service.

22. A method according to claim 21, wherein said step of distributing comprises distributing the unique identifiers electronically.

23. A method according to claim 22, wherein said step of distributing the unique identifiers comprises:
sending a plurality of text messages to respective telephones, each text message a different one of said unique identifiers.

24. A method according to claim 21, wherein said step of distributing the unique identifiers comprises:
transmitting information requesting a response from a recipient;
receiving and verifying a response from a recipient to said information; and
where a response is verified, sending one of said unique identifiers to the recipient.

25. A method according to claim 24, wherein said information comprises a question, partially completed word or name.

26. A method according to claim 20, wherein said unique identifiers are telephone numbers, viewing card numbers or customer reference numbers.

27. A method according to claim 1, comprising:
transmitting further information in conjunction with a further instance of promotional material;
receiving responses to said further information from viewers of said programme content distribution service;
selecting one of said responses and obtaining viewer information relating to a recipient from whom said selected response was received, based on the identifier held by said recipient; and
allocating a reward to said recipient using said viewer information.

28. A method according to claim 1, comprising:
transmitting further information in conjunction with a further instance of promotional material;
receiving responses to said further information from recipients of said programme content distribution service;
allocating a code to recipients from whom one of said responses was received;
selecting one of said codes;
transmitting said selected code in conjunction with a yet further instance of promotional material;
in response to a request from a recipient of said programme content distribution service, determining whether a code held by said recipient matches said selected code, obtaining recipient information relating to said recipient, based on the identifier held by said recipient, and allocating a reward to said recipient using said recipient information.

29. A system for providing an incentive to receive content, comprising:
a database to store a plurality of unique identifiers;
a processor to select one of said unique identifiers from said database for presentation by a programme content distribution service; and
a request reception service to receive a request from one of said recipients, determine whether an identifier held by said one recipient matches said selected unique identifier and, in response to a positive determination, allocate a reward to said one recipient.

30. A system for providing an incentive to receive content, comprising:
a database to store a plurality of unique identifiers, said unique identifiers comprising a plurality of non-unique elements;
a processor to select one or more of said non-unique elements for presentation by a programme content distribution service; and
a request reception service to receive a request from one of said recipients, determine whether an identifier held by said one recipient comprises a predetermined number of said one or more selected non-unique elements and, in response to a positive determination, allocate a reward to said one recipient.

31. A system according to claim 29, wherein:
said processor is arranged to generate said plurality of unique identifiers.

32. A method of determining whether a recipient of a programme content distribution service is eligible for a reward, comprising:
receiving an indication of a first unique identifier held by the recipient;
obtaining an indication of a second unique identifier presented in conjunction with content transmitted via a programme content distribution system;
determining whether the first unique identifier matches the second unique identifier and, in response to a positive determination, notifying the recipient of their eligibility for the reward.

33. A method of determining whether a recipient of a programme content distribution service is eligible for a reward, comprising:
receiving an indication of a unique identifier held by the recipient;
obtaining an indication of one or more non-unique elements presented in conjunction with content transmitted via a programme content distribution system;
determining whether the unique identifier includes a predetermined number of said one or more non-unique elements and, in response to a positive determination, notifying the recipient of their eligibility for the reward.

34. A method according to claim 32, wherein said step of notifying comprises sending a text message or e-mail to the recipient.

35. A method according to claim 33, wherein said step of receiving the indication of the unique identifier comprises providing a form on a web page for completion by the recipient.
